(19) United States
(12) Patent Application Publication
(10) Pub. No.: US 2015/0042296 A1
(43) Pub. Date: Feb. 12, 2015

(54) VOLTAGE REGULATOR SOFT START

(71) Applicant: SK hynix memory solutions inc., San Jose, CA (US)

(72) Inventors: Zichuan Cheng, San Jose, CA (US); Danfeng Xu, Cupertino, CA (US)

(21) Appl. No.: 14/307,104

(22) Filed: Jun. 17, 2014

Related U.S. Application Data
(60) Provisional application No. 61/840,715, filed on Jun. 28, 2013.

(51) Int. Cl. H02M 3/158; G05F 1/56; H02M 1/36

(52) U.S. Cl. CPC H02M 3/158; H02M 1/36; G05F 1/56
USPC 323/269

(57) ABSTRACT

A linear voltage regulator is disclosed. The linear voltage regulator includes an amplifier. The linear voltage regulator also includes a plurality of power devices. At least one of the power devices is electrically coupled to the amplifier. A switch is configured to control at least one power device of the plurality of power devices and a delay component is configured to trigger the switch.

### CROSS REFERENCE TO OTHER APPLICATIONS

This application claims priority to U.S. Provisional Patent Application No. 61/840,715 (Attorney Docket No. LINKP139+) entitled NEW LOW DROPOUT REGULATOR SOFT START filed Jun. 28, 2013 which is incorporated herein by reference for all purposes.

### BACKGROUND OF THE INVENTION

Often linear voltage regulators are utilized to maintain a steady voltage of a circuit. However, the loading circuit can introduce high frequency noise into the circuit. In order to reduce the noise as well as further steady the voltage of the circuit, a large bypass capacitor is often connected to an output of a linear regulator. When the linear voltage regulator is initially powered on, there is often a large current drawn from a power supply to charge the large bypass capacitor. This large rush of current may cause the voltage output of the power supply to dip severely due to the resistance of a power switch of the power supply. However for many applications, the dip in voltage may lead to a failure of circuit components that are sensitive to voltage fluctuations. Therefore, there exists a need for a better way to handle powering of a linear voltage regulator.

### BRIEF DESCRIPTION OF THE DRAWINGS

Various embodiments of the invention are disclosed in the following detailed description and the accompanying drawings.

FIG. 1 is a circuit schematic diagram illustrating an example linear voltage regulator.

FIG. 2 shows graphs of waveforms illustrating an example of circuit parameter waveforms when initially charging a bypass capacitor.

FIG. 3 is a circuit schematic diagram illustrating an example linear voltage regulator with smooth start.

FIG. 4 shows graphs of waveforms illustrating an example of circuit parameter waveforms when initially charging a bypass capacitor.

FIG. 5 is a generic circuit schematic diagram illustrating an example linear voltage regulator with smooth start using a variable number of power device stages.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A linear voltage regulator is disclosed. For example, a low-dropout regulator is disclosed. The linear voltage regulator includes an amplifier. For example, a differential electronic amplifier connected to a reference voltage of the linear voltage regulator is included. The linear voltage regulator further includes a plurality of power devices, wherein at least one of the power devices is electrically connected to the amplifier. For example, the linear voltage regulator includes a plurality of different power transistors that are sized differently. A switch is configured to control at least one of the power devices, and a delay component is configured to trigger the switch.

For example, initially when the linear voltage regulator is powered on, a small sized power device with a comparatively larger resistance is utilized by the linear voltage regulator to provide limited current to a bypass capacitor. Although this current limited by larger resistance power device effectively limits the current to reduce the voltage dip of the power supply, this power device may not be ideal to be utilized by the linear voltage regulator in its normal operation that may require larger power and current or when the bypass capacitor needs to be charged faster (e.g., after the bypass capacitor is charged to a certain point, more current may be allowed without a severe voltage dip because the capacitor has built up voltage). After a delay time of the delay component, the delay component triggers the switch to allow the linear voltage regulator to utilize another larger sized power transistor with a comparatively smaller resistance to enable larger current to be provided by the linear voltage regulator.

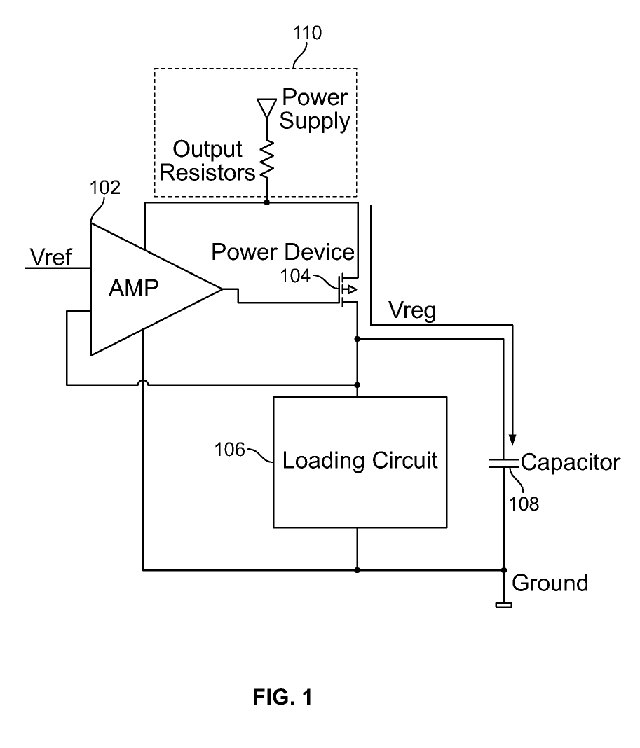

FIG. 1 is a circuit schematic diagram illustrating an example linear voltage regulator. The linear voltage regulator shown in FIG. 1 includes amplifier 102 and power device 104. This linear voltage regulator is utilized to maintain a steady voltage for loading circuit 106. Examples of loading circuit 106 include any circuit desired to be voltage regulated by the linear voltage regulator. Bypass capacitor 108 is connected to the output of the linear voltage regulator and functions to reduce the noise as well as further steady the voltage provided to loading circuit 106. Power supply 110 provides power to the circuit shown in FIG. 1. Power supply 110 has an internal resistance (e.g., due to power switch utilized to limit current leakage). When the linear voltage regulator is switched on, a large current is provided to charge capacitor 108. Power device 104 is sized large with a small resistance (e.g., effectively a short across power device 104 when first powered on) and large current providing capacity to allow the linear voltage regulator of FIG. 1 to quickly regulate and maintain voltage at its output. However, the initial large current provided to charge capacitor 108 causes a dip in the voltage output of power supply 110 (e.g., caused by large current passing through resistance of the power supply) until the current is reduced as capacitor 108 becomes charged. This dip in the power supply voltage may cause circuit failure if the voltage dip of the power supply is large. Not only does power supply 110 supply power to the circuit shown in FIG. 1, it may provide power to other circuit components not shown in FIG. 1 that may be sensitive to the large fluctuation in voltage. Thus it may be desirable to minimize the dip in power supply output voltage caused by the initial charging of the bypass capacitor.

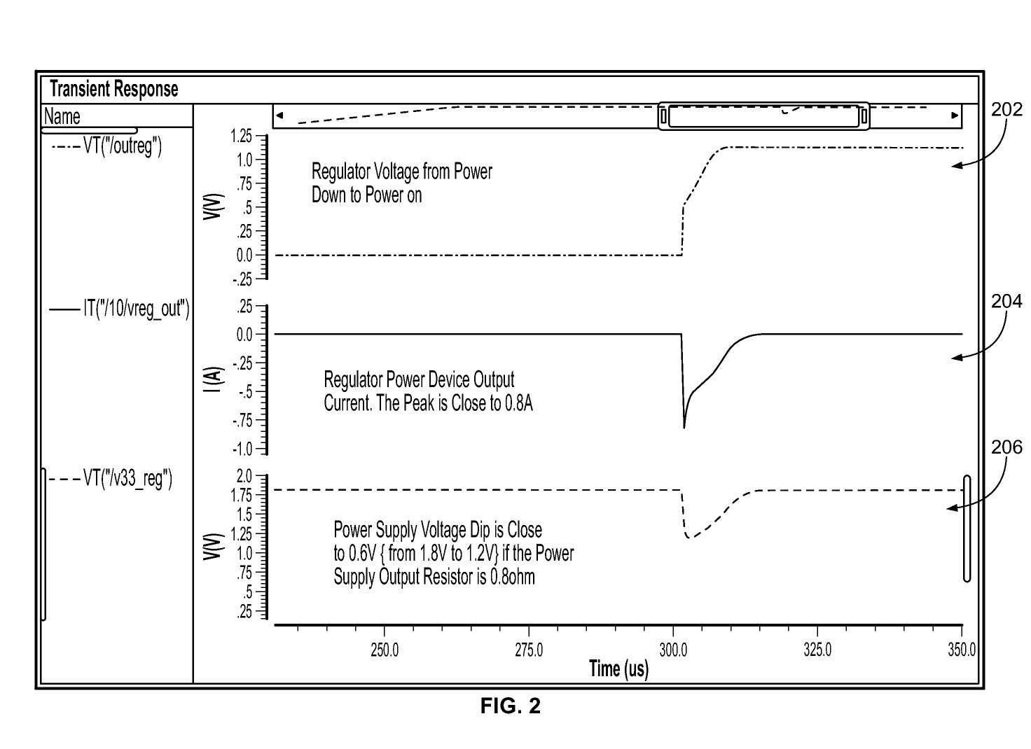

FIG. 2 shows graphs of waveforms illustrating an example of circuit parameter waveforms when initially charging a bypass capacitor. For example, FIG. 2 shows example transient response waveforms of the circuit of FIG. 1.

Graph 202 shows the voltage of an output voltage of a linear voltage regulator (e.g., voltage output of the linear regulator of FIG. 1) after being switched on. The output voltage of the linear voltage regulator quickly rises as a bypass capacitor (e.g., capacitor 108 of FIG. 1) is charged to the regulated voltage of the linear voltage regulator.

Graph 204 shows the corresponding output current of the linear voltage regulator of graph 202 after being switched on. The output current of the linear voltage regulator spikes to a large negative current to charge the bypass capacitor and returns to zero once the bypass capacitor is charged. This large spike in current will often cause a power supply voltage to dip severely.

Graph 206 shows the output voltage of a power supply (e.g., power supply 110 of FIG. 1) corresponding to graphs 202 and 204 showing a negative dip in output voltage due to the large negative current spike shown in graph 204. This voltage dip shown in graph 206 is undesirable and may cause sensitive circuit components to function improperly.

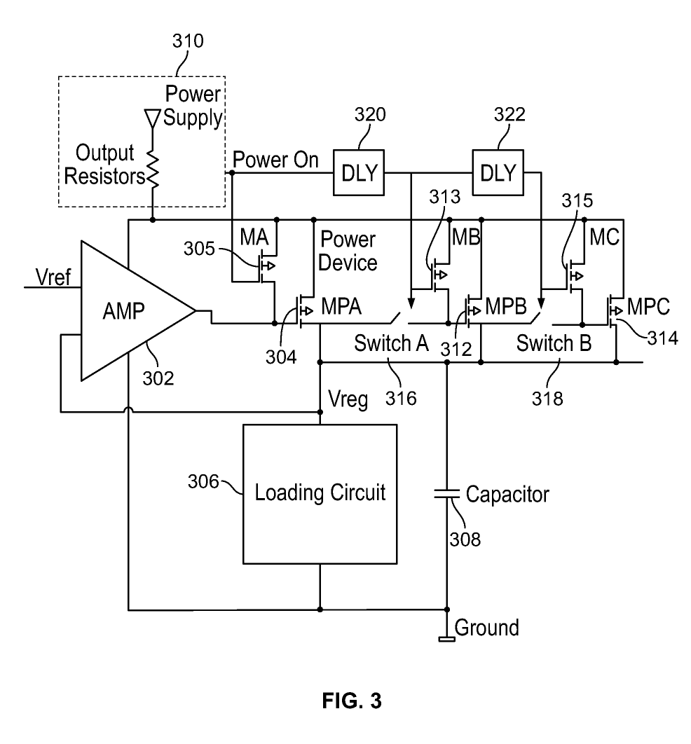

FIG. 3 is a circuit schematic diagram illustrating an example linear voltage regulator with smooth start. The linear voltage regulator shown in FIG. 3 includes amplifier 302, power device 304, switch device 305, power device 312, switch device 313, power device 314, switch device 315, switch 316, switch 318, delay component 320, and delay component 322. In some embodiments, the linear voltage regulator is a low-dropout (i.e., LDO) regulator. For example, the desired voltage to be outputted by the linear voltage regulator is less than a power supply voltage. Examples of amplifier 302 include a differential amplifier, an operational amplifier, and any other type of amplifier. Amplifier 302 is provided a reference voltage as an input. For example, a desired output voltage of the linear voltage regulator is provided as an input. Examples of power devices 304, 312 and 314 include a transistor, a power transistor, a field-effect transistor, junction gate field-effect transistor, a bipolar transistor, and any other type of transistor. Examples of switch device 305, switch device 313 and switch device 315 include a transistor switch and any other type of switch. Examples of switch 316 and 318 include a transistor switch, an electrical mechanical switch, a solid-state switch, and any other type of switch. Examples of delay component 320 and delay component 322 include a counter component, an oscillator, a signal control logic, and any other component that provides a delayed signal.

The linear voltage regulator is utilized to provide a steady voltage to loading circuit 306. Examples of loading circuit 306 include an analog to digital converter, a gating signal generator, a timing signal generator, a phase-locked loop, a clock, an oscillator, a memory controller, a memory component, a storage controller, a storage component, a controller of embedded Multi-Media Controller (i.e., eMMC), a NAND flash memory controller, and any circuit desired to be voltage regulated by the linear voltage regulator. Bypass capacitor 308 is connected to the output of the linear voltage regulator and functions to reduce the noise as well as further steady the voltage provided to loading circuit 306. For example, the bypass capacitor is sized on the microfarad level and may conform to a specification/standard such as a standard for eMMC devices. Power supply 310 provides power to the circuit shown in FIG. 3. Power supply 310 includes a resistance (e.g., due to a power switch utilized to limit current leakage).

The linear voltage regulator and loading circuit 306 of FIG. 3 may be dynamically cycled on and off to conserve power when not in use. When the linear voltage regulator is switched on, a large current is prevented from being provided to charge capacitor 308 because power device 304 has been sized small to limit the current being provided to charge capacitor 308. For example, when the linear voltage regulator of FIG. 3 is initially powered on, power device 304 is enabled by switch device 305 (e.g., when switch device 305 is off, power device 304 is on/enabled), power device 312 is disabled by switch device 313 (e.g., when switch device 313 is on, power device 312 is off/disabled), power device 314 is disabled by switch device 315 (e.g., when switch device 315 is on, power device 314 is off/disabled), switch 316 is off, and switch 318 is off (i.e., only power device 304 is enabled and other power devices are disabled upon initial power on of the linear voltage regulator to charge the bypass capacitor). Because power device 304 has been sized small, the amount of current able to be provided by power device 304 is limited (e.g., initial resistance of power device 304 is comparatively large as compared to other power devices) and consequently the power supply voltage drop of FIGS. 1 and 2 can be avoided. However, by sizing the power device 304 to be small, the time to charge capacitor 308 may be long (e.g., during the charge time of the bypass capacitor, loading circuit 306 may not be functional and loading circuit 306 is enabled after capacitor 308 is charged) and power device 304 alone may not be able to provide enough power and current during the operation of the linear voltage regulator after capacitor 308 has been charged.

In some embodiments, as capacitor 308 becomes charged (e.g., capacitor builds up voltage), less current will be drawn by capacitor 308 and an additional power device is added to increase the charging of the current within an acceptable level and/or allow the linear voltage regulator to be able to handle voltage fluctuations more effectively with the additional power device. After a first amount of delay time (e.g., amount of time required to charge capacitor 308 to a desired level using power device 304), delay component 320 activates and turns on switch 316 and effectively turns off switch device 313 to turn on power device 312. Power device 312 may be sized larger than power device 304 and power device 312 is able to provide additional/more current to charge capacitor 308 and/or maintain desired voltage output of the voltage regulator. For example, the resistance of power device 312 is smaller than the resistance of power device 304 and by turning on power device 312, the effective resistance of the combination of power device 312 and power device 304 becomes smaller (e.g., resistances combined in parallel), allowing larger current to flow. The size of power device 312 may be selected such that the effective combined resistances of power device 304 and power device 312 will allow a desired amount of current to be provided by the linear voltage regulator. In some embodiments, rather than allowing both power device 304 and power device 312 to be utilized at the same time after the first delay time, power device 304 is turned off/disabled when power device 312 is turned on/enabled. In various embodiments, power device 312 may be sized larger, equal or smaller than power device 304.

After an additional second amount of delay time has passed (e.g., amount of time required to charge capacitor 308 to a second desired level (e.g., fully charged) using power device 304 and power device 312), delay component 322 activates and turns on switch 318 and effectively turns off switch device 315 to turn on power device 314. Power device 314 may be sized larger than power device 304 and power device 312, and power device 314 is able to provide additional/more current to charge capacitor 308 and/or maintain desired voltage output of the voltage regulator. For example, the resistance of power device 314 is smaller than the resistance of power device 312 and by turning on power device 314, the effective resistance of the combination of power device 314, power device 312 and power device 304 becomes smaller (e.g., resistances combined in parallel), allowing larger current to flow. The size of power device 314 may be selected such that the effective combined resistances of power device 304, power device 312 and power device 314 will allow a desired amount of current to be provided by the linear voltage regulator. In some embodiments, rather than allowing multiple power devices to be utilized at the same time, power device 312 is turned off/disabled when power device 314 is turned on/enabled. In various embodiments, power device 314 may be sized larger, equal or smaller than power device 312.

In various embodiments, the delay time of delay components and the sizes of power devices of the linear voltage regulator are determined based at least in part on one or more of the following: a size of a bypass capacitor, an amount of time required for the bypass capacitor to be charged, an amount of time required for the voltage regulator to provide a stable voltage, a resistance of a power supply, an amount of power supply voltage fluctuation tolerance, and a desired maximum current output of the voltage regulator.

For example, a specification requires a voltage output of the linear voltage regulator to be stable within less than 100 us after power on and based on this time value, 40 us is selected as the first delay time to activate switch 316 and 20 us is selected as the second delay time to activate switch 318 (e.g., taking into account +/−25% clock frequency various utilized by delay component 320 and delay component 322).

In another example, a specification requires a voltage drop of a power supply to be no more than 150 mV when the linear voltage regulator is powered on. In this example, the power supply has a resistance of 0.8 ohms and provides 1.8V, which requires the current to be less than 187.5 mA at any time and to drop no more than 150 mV. For example, initially the voltage on capacitor 308 is 0. Because Voltage=Current*Resistance (1.8V−0=187.5 mA(0.8 ohms+power device resistance)), resistance of power device(s) to be utilized upon voltage regulator power on initially should be greater or equal to 8.8 ohms. After the first delay time, the voltage on capacitor 308 will be charged up (0.7V for example). Base on the formula above (1.8V−0.7V=187.5mA*(0.8 ohm+power device resistance)), resistance of power devices can be reduce to 5 ohm. So another power device may be enabled and the resistance of the second power device is added in parallel with resistance of the initial power device to charge the bypass capacitor. A final third large power device may be enabled after the bypass capacitor is charged to enable the voltage regulator to maintain a desired output voltage using the large power device (e.g., by not enabling the large power device until the bypass capacitor is charged, the large power device does not spike output current during the initial power on to charge the capacitor).

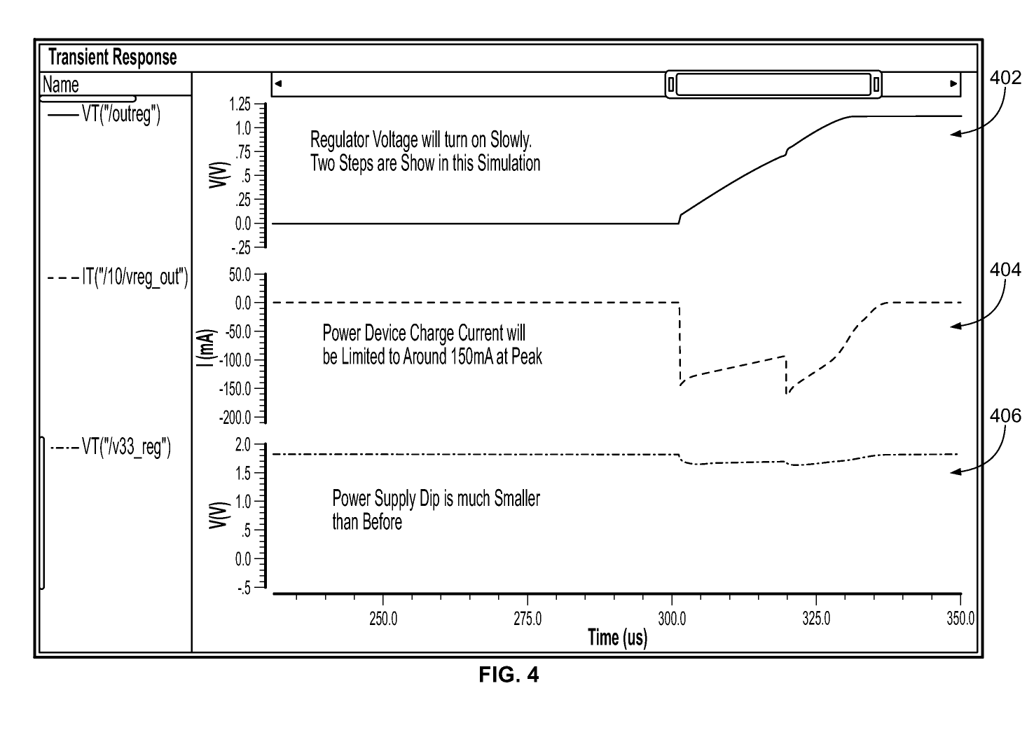

FIG. 4 shows graphs of waveforms illustrating an example of circuit parameter waveforms when initially charging a bypass capacitor. For example, FIG. 4 shows example waveforms of the circuit of FIG. 3.

Graph 402 shows the voltage of an output voltage of a linear voltage regulator (e.g., voltage output of the linear regulator of FIG. 3) after being switched on. The output voltage of the linear voltage regulator rises in steps as a bypass capacitor (e.g., capacitor 308 of FIG. 3) is charged to the regulated voltage of the linear voltage regulator. As compared to graph 202 of FIG. 2, it takes longer for the bypass capacitor of graph 402 to charge due to a smaller power device being utilized to initially charge the bypass capacitor as compared to the circuit of graph 202. The step of graph 402 is caused by an additional power device being enabled after a delay time.

Graph 404 shows the corresponding output current of the linear voltage regulator of graph 402 after being switched on. The output current of the linear voltage regulator spikes to a maximum negative current of 150 mA to charge the bypass capacitor using a first power device, then spikes to the maximum negative current again when a second power device is enabled after the delay time.

Graph 406 shows the output voltage of a power supply (e.g., power supply 310 of FIG. 3) corresponding to graphs 402 and 404 showing a minor negative dip in output voltage due to the negative current spike shown in graph 404. An additional dip is caused when a second power device is enabled after the delay time. As compared to the voltage dip shown in graph 206 of FIG. 2, the undesirable voltage dip of graph 406 is significantly smaller.

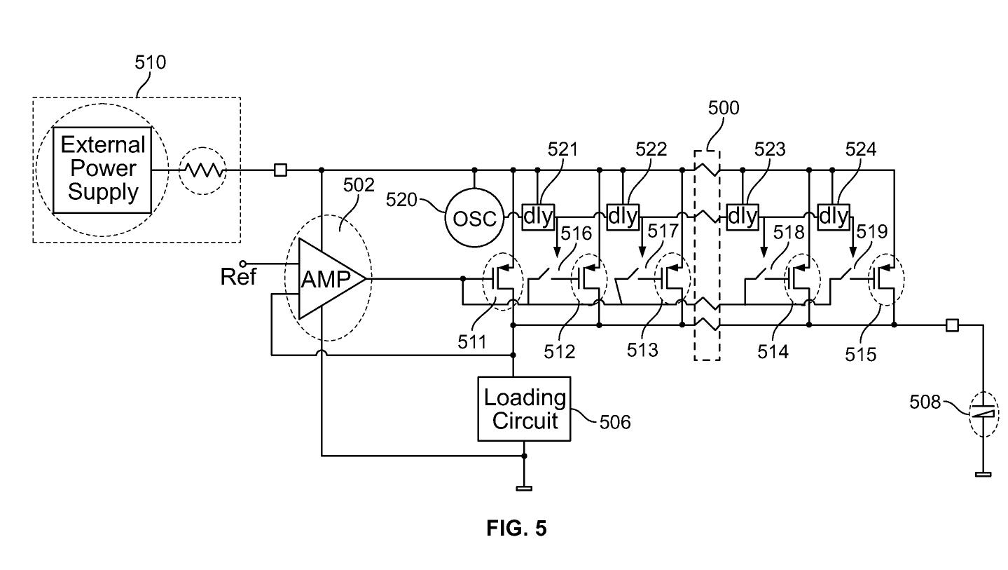

FIG. 5 is a generic circuit schematic diagram illustrating an example linear voltage regulator with smooth start using a variable number of power device stages. Although the example shown in FIG. 3 shows three stages of power devices being turned on/enabled at various delay times (e.g., one at initial power on then two subsequent stages), any number of stages may be utilized as shown in FIG. 5. For example, only two stages of power devices may be utilized. In another example, four or more stages may be utilized, as shown in FIG. 5. In some embodiments, FIG. 5 shows the example circuit shown in FIG. 3 expanded to show that any number of power device stages may be utilized. The linear voltage regulator shown in FIG. 5 includes amplifier 502, power device 511, power device 512, power device 513, power device 514, power device 515, switch 516, switch 517, switch 518, switch 519, oscillator 520, delay component 521, delay component 522, delay component 523, and delay component 324. In some embodiments, the linear voltage regulator is a low-dropout (i.e., LDO) regulator.

Examples of amplifier 502 include a differential amplifier, an operational amplifier, and any other type of amplifier. Examples of power devices 511-515 include a transistor, a power transistor, a field-effect transistor, junction gate field-effect transistor, a bipolar transistor, and any other type of transistor. Examples of switches 516-519 include a transistor switch, an electrical mechanical switch, a solid-state switch, and any other type of switch. Examples of delay components 521-524 include a counter component, a signal control logic, and any other component that provides a delayed signal. Examples of oscillator 520 include a ring oscillator and any other type of oscillator. For example, delay components 521-524 determine time using a signal provided by oscillator 520. Dashed area 500 in FIG. 5 shows that additional stage power device stages may be added with each additional power device, delay component, and switch. Examples of loading circuit 506 include an analog to digital converter, a gating signal generator, a timing signal generator, a phase-locked loop, a clock, an oscillator, a memory controller, a memory component, a storage controller, a storage component, a controller of embedded Multi-Media Controller, NAND flash memory controller, and any circuit desired to be voltage regulated by the linear voltage regulator. Bypass capacitor 508 is connected to the output of the linear voltage regulator and functions to reduce the noise as well as further steady the voltage provided to loading circuit 506. Power supply 510 provides power to the circuit shown in FIG. 5. Power supply 510 has an internal resistance.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A linear voltage regulator, comprising:
an amplifier;
a plurality of power devices, wherein at least one of the power devices is electrically coupled to the amplifier;
a switch configured to control at least one power device of the plurality of power devices; and
and a delay component configured to trigger the switch.

2. The linear voltage regulator of claim 1, wherein the linear voltage regulator is a low-dropout regulator.

3. The linear voltage regulator of claim 1, wherein the switch is configured to enable at least one of the power devices to provide current to a capacitor.

4. The linear voltage regulator of claim 3, wherein the capacitor is a bypass capacitor.

5. The linear voltage regulator of claim 1, wherein the delay component triggers the switch after a first delay time.

6. The linear voltage regulator of claim 5, further comprising a second switch configured to control at least a different one of the power devices and further comprising a second delay component configured to trigger the second switch at a second delay time.

7. The linear voltage regulator of claim 1, wherein when the linear voltage regulator is initially powered on, only one of the plurality of power devices is enabled to provide current to a capacitor.

8. The linear voltage regulator of claim 1, further comprising a plurality of transistor switches, wherein each power device of the plurality of power devices is controlled by a different transistor switch of the plurality of transistor switches.

9. The linear voltage regulator of claim 1, wherein the switch is configured to turn off a transistor switch when triggered by the delay component.

10. The linear voltage regulator of claim 1, wherein each of the plurality of power devices is sized differently to provide a different amount of maximum current.

11. The linear voltage regulator of claim 1, wherein each of the plurality of power devices is sized differently to provide a different amount of resistance.

12. The linear voltage regulator of claim 1, wherein the plurality of power devices are configured to be connected in parallel.

13. The linear voltage regulator of claim 1, wherein the plurality of power devices includes a plurality of power transistors.

14. The linear voltage regulator of claim 1, wherein the delay component includes a counter connected to an oscillator.

15. The linear voltage regulator of claim 1, wherein the linear voltage regulator is configured to regulate voltage of a storage controller.

16. The linear voltage regulator of claim 1, wherein the linear voltage regulator is configured to be dynamically cycled on and off to conserve power.

17. The linear voltage regulator of claim 1, wherein a delay time of the linear voltage regulator is configured to be determined based at least in part on a maximum amount of settling time allowed for an output of the linear voltage regulator to become stable.

18. The linear voltage regulator of claim 1, wherein resistance sizes of each of the plurality of power devices have been configured based at least in part on a maximum voltage fluctuation of a power supply.

19. The linear voltage regulator of claim 1, wherein the switch is configured to control at least one of the power devices by effectively combining in parallel a resistance of at least two of the plurality of power devices.

20. The linear voltage regulator of claim 1, wherein the delay component is configured to enable at least one of the power devices and disable a different one of the power devices.
